(19) United States
(12) Patent Application Publication
(10) Pub. No.: US 2023/0201912 A1
(43) Pub. Date: Jun. 29, 2023

(54) POLYMER MOLDS, APPARATUS, AND METHOD

(71) Applicant: Plastipak Packaging, Inc., Plymouth, MI (US)

(72) Inventors: Marc A. Pedmo, Litchfield, MI (US); Andrew Fischer, Medina, OH (US)

(21) Appl. No.: 15/590,375

(22) Filed: May 9, 2017

Related U.S. Application Data
(60) Provisional application No. 62/333,443, filed on May 9, 2016.

(51) Int. Cl. B22C 9/06; B29C 33/00; B28B 7/34

(52) U.S. Cl. CPC B22C 9/061; B28B 7/348; B29C 33/00

(57) ABSTRACT

A mold assembly for manufacturing molded articles includes a plurality of mold portions that are comprised of a polymer and form a mold cavity. In embodiments, the polymer has a thermal conductivity (k) of less than about 0.5. Although, some embodiments may have higher conductivity values. In embodiments, the polymer comprises polycarbonate. Methods for making and using polymer mold portions and assemblies are also disclosed.

### CROSS-REFERENCE TO RELATED APPLICATIONS

This application claims the benefit of U.S. Provisional Pat. Application Serial No. 62/333,443, filed on May 9, 2016, the disclosure of which is hereby incorporated herein by reference in its entirety.

### TECHNICAL FIELD

The present disclosure relates generally to blow molds, including blow molds comprising a polymer and having insulating properties or characteristics.

### BACKGROUND

Conventional blow molds are commonly made from alloys or metals. Such blow molds often require additional systems or processes - such as hot oil or electrical heating - to remove heat from the molds.

With a typical heat set process, an intermediate article, such as a preform, may be heated to greater than 100° C., with a preferred temperature of greater than 120° C. The blow mold temperature may be generally elevated between 100° C. and 140° C. When the preform is blown against the hot mold, the polymer associated with the preform may relax and the crystallites may grow in number and size, which can cross-link the polymer and minimize polymer shrinkage (retraction to amorphous state). Such a process can permit higher filling temperatures - for example, above a T_{g} (glass transition temperature). The polymer of the formed article may then be “set” by a blowing and cooling process that cools the polymer below the T_{g} and maintains the final shape of the container. The cooling process may involve high pressure air cooling that occurs within the blow mold. In some instances, contact with the blow mold, may also reduce the polymer temperature. Typical blow molds for such processes are comprised of stainless steel and involve heated oil that passes through a heat exchanger or electrical heaters. However, conventional stainless steel molds can be heavy, weighing as much as 70 pounds or more per mold half. Such molds could, in some circumstances, pose a safety concern in view of the associated weight and/or heat and heat transfer requirements.

Further, as industry production rates continue to increase, the amount of time for polymer relaxation and blowing can decrease significantly. At the same time, the cost associated with manufacturing and maintaining molds capable of heating the molding surface has increased. And, the benefit of the mold contact may become reduced with cycle time reduction and reduced part-mold contact time.

Among other things, it can be desirable to provide molds that address some or all of the aforementioned challenges.

### SUMMARY

A mold assembly for manufacturing molded articles includes a plurality of mold portions comprised of a polymer. In embodiments, the polymer has a thermal conductivity (k) of less than about 0.5. In embodiments, the polymer may, for example and without limitation, comprise polycarbonate. Methods of making and using polymer mold assemblies are also disclosed.

Various aspects of the present disclosure will become apparent to those skilled in the art from the following detailed description of the various embodiments, when read in light of the accompanying drawings.

### BRIEF DESCRIPTION OF THE DRAWINGS

Embodiments of the present disclosure will now be described, by way of example, with reference to the accompanying drawings.

FIGS. 1-3 generally illustrate a container and aspects of a blow mold assembly embodying aspects of the present disclosure.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

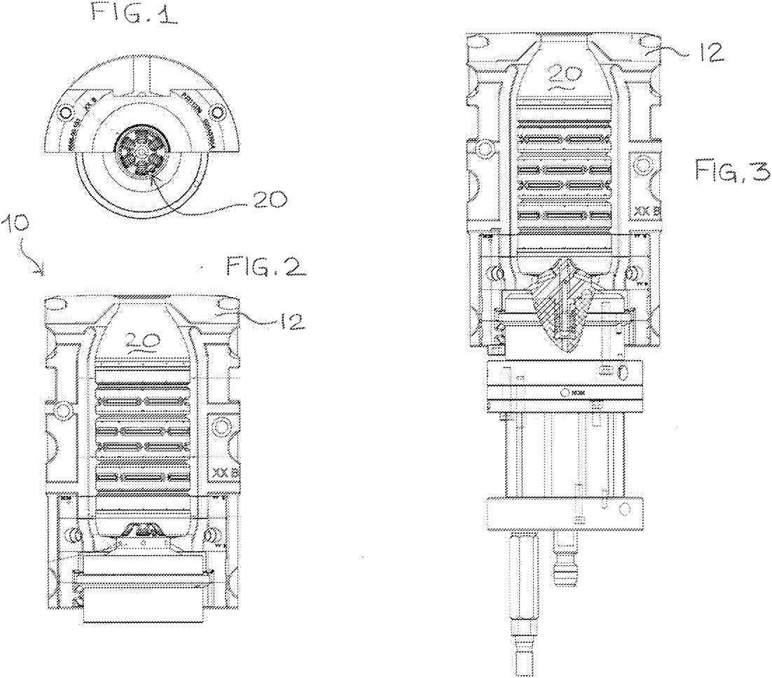

FIGS. 1-3 generally illustrate an embodiment of a blow mold 10 according to aspects of the present disclosure. The blow mold 10 may comprise a plurality of separable mold portions 12 that form a mold cavity. The mold portions 12 may together form all or a portion of an intermediate or a final mold. In embodiments, the article formed from the blow mold may, for example, comprise a plastic container or bottle 20. While a blow mold is disclosed, it is noted that the teachings of the instant disclosure may be applicable to other types of molds known to those of skill in the art.

In embodiments, a blow mold 10 may be comprised of a polymer or other insulating material suitable for the environment or application. For example, the polymer may comprise a sufficiently durable polymer - such as, without limitation, a polycarbonate. However, in embodiments the blow mold may be comprised of other materials in addition to a polymer. With some embodiments, the blow mold may include portions that have other materials that are suitable for use in a mold, including, for example, one or more metals. In embodiments, the blow mold, or portions thereof, may include a filler - for example and without limitation, a fiberglass filler. A filler may, among other things, improve material properties, including modulus of elasticity or other measures of stiffness. In embodiments in which a filler is included, the filler may, for instance, comprise up to or about 20% of the material. However, the specific percentage of a filler may be varied, even widely, to address the objectives or requirements of an application.

Additionally, with some embodiments the blow mold may include carbon black. For example and without limitation, in some embodiments the blow mold, or at least a portion thereof, may comprise a carbon black-filled polycarbonate. The inclusion of carbon black can, among other things, provide an opaque, black color and, may provide a “metal” look to a polymer mold.

The blow molds may, for example, be injection molded or milled, or may be formed using other known techniques. The molds may be provided as mold halves, or other divisions, that may be assembled to provide a full mold shell/unit. By way of example only, and without limitation, a multi-ton (e.g., 300-ton) injection molder may heat the polymer up to about 300° F. to about 350° F. for injecting. Depending on the material properties, such as the material properties of the polymer forming at least a portion of the mold, the temperature of the polymer will typically be sufficiently high for the polymer to flow (e.g., via a screw) and to be injection molded to form a mold. For example and without limitation, in embodiments a polycarbonate may be injected at about 300° F. to about 350° F. In embodiments, a holding pressure may be maintained while cooling the tool down, which may improve part quality. Additional or other means to heat/cool faster or more efficiently may be employed - including, for example and without limitation, heat rods, steam, and other means.

Additionally, embodiments may not incorporate chill lines into the blow molds.

By virtue of associated material properties, the polymer material from which the blow mold 10 is formed can, among other things, serve as an insulating material. Moreover, by employing a polymer mold, the mold can serve as an insulator to permit the formation of an article that can remain hot through a blow molding process and can require comparatively slower cooling (as compared to that associated with a conventional steel or metal mold). Moreover, a blow mold that is comprised of a polymer can provide a significant reduction in weight, and can serve to alleviate surface temperature issues/concerns. Also, given the insulating properties of the mold, a polymer mold may be able to better facilitate and/or maintain crystal growth, as the polymer rate of cooling may not be negatively affected by a thermally conductive mold surface. That is, in contrast with conventional steel or metal molds, which may be comparatively more conducive, polymer molds may provide a slower cooling of a polymer in a mold, which in turn can facilitate the growth and number of crystallites associated with the polymer.

A polymer blow mold will typically have a materially lower thermal conductivity than a conventional steel or metal mold. That is, heat transfer occurs at a lower rate across materials of low thermal conductivity than across materials with a high thermal conductivity. Materials with low thermal conductivity may serve as a thermal insulator. As such, a blow mold comprised of a polymer can serve as an insulator. In embodiments, the thermal conductivity -i.e., denoted k, and expressed in thermal conductivity units W//(m·K) in the SI system and Btu/(hr ft °F) in the English/Imperial system - of a polymer mold may, for example and without limitation, have a k of less than about 0.5. For example and without limitation, the k for polycarbonate (e.g., at 23° C.) may range from 0.19 - 0.22. However, for some embodiments, the thermal conductivity k may range as high as 10. Moreover, for some embodiments, the thermal conductivity k may range up to, or just below, a number at which the heat transfer of the mold removes too much heat from an article (e.g., a preform) so that the necessary thermal properties for a heat set container cannot be satisfied without adding a heat source to the mold. The foregoing thermal conductivity k values may be contrasted with a stainless steel mold, which might have a k of between 12 and 45, or an aluminum mold, which may have a k of about 205.

Additionally, creation of the mold from a polymer can provide for comparatively rapid mold production - whether the mold is injected, extruded, cast, or machined. That is, the formation of molds from a polymer can be very expeditious and efficient.

While various applications are contemplated, polymer molds that provide heat transfer properties of an insulator may be particularly useful in connection with the formation of hot-fill related articles, such as hot-fill containers. Further, the use of such polymer molds can improve the crystallinity of the polymer associated with the formed article and, under relevant circumstances, can facilitate improved hot-filling of an associated article.

Moreover, because of the higher heat transfer values associated with them, conventional molds that are comprised of stainless steel or metals commonly require additional systems or processes - for example, hot oil or electrical heating - to remove heat from the molds. In contrast, embodiments of polymer blow molds may not need such additional measures or systems to supplement the removal of heat from the molds.

Blow molds in accordance with embodiments of the present disclosure may be used, for example and without limitation, to produce “heat set” plastic containers. Such containers, as known in the art, may have improved or increased thermal properties for use in “hot-fill” operations or applications. Additional disclosure concerning molds and hot-fill applications may be found, for example, in U.S. Pat. Nos. 5,145,632 and 5,382,157, which are incorporated herein by reference.

It is noted that various embodiments are described herein to various apparatuses, systems, and/or methods. Numerous specific details are set forth to provide an understanding of the overall structure, function, manufacture, and/or use of the embodiments as described in the specification and illustrated in accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “embodiments,” “one embodiment,” or “an embodiment,” or the like, means that a particular feature, structure, or characteristic described in connection with the embodiment is included in at least one embodiment. Thus, appearances of the phrases “in various embodiments,” “in embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Any joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure.

Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification as the best mode presently contemplated for carrying out the teachings of the present disclosure, but that the scope of the present disclosure will include any embodiments falling within the foregoing description and the appended claims.

1. A mold assembly for manufacturing blow molded plastic containers, the mold assembly comprising:
a plurality of mold portions that form a blow mold cavity configured to form all or a portion of a plastic container,
wherein the mold portions are devoid of metal on a container contact surface and are devoid of metal at an interface of the molds portions, the mold portions are primarily comprised of a polymer, the polymer forms the blow mold cavity for contact with said plastic containers to be formed from the mold assembly, the mold portions include a non-metallic filler, the polymer mold portions have a thermal conductivity (k) of less than about 0.5 W/(m·K), and the polymer is an insulator.

2. The mold assembly of claim 1, wherein the blow molded plastic containers comprise plastic bottles.

3. The mold assembly of claim 1, wherein the polymer mold portions have a thermal conductivity (k) such that the mold portions can remove some heat from the plastic container.

4. The mold assembly of claim 1, wherein the polymer mold portions have a thermal conductivity (k) that ranges from about 0.19 W/(m·K) to about 0.22 W/(m·K).

5. The mold assembly of claim 1, wherein the polymer mold portions have a thermal conductivity (k) of 10 W/(m·K) or less.

6. The mold assembly of claim 1, wherein the polymer comprises a polycarbonate.

7. (canceled)

8. The mold assembly of claim 1, wherein the filler comprises up to 20%, by weight, of the mold portions.

9. The mold assembly of claim 1, wherein the filler comprises about 20%, by weight, of the mold portions.

10. The mold assembly of claim 1, wherein the filler comprises fiberglass.

11. The mold assembly of claim 1, wherein the mold portions include carbon black.

12. The mold assembly of claim 1, wherein the mold portions are injection molded.

13. The mold assembly of claim 1, wherein the mold portions are milled.

14. The mold assembly of claim 1, wherein the mold portions do not include chill lines.

15. The mold assembly of claim 1, wherein the mold portion includes a non-polymer material.

16. (canceled)

17. (canceled)

18. A method for making a mold assembly as recited in claim 1, the method comprising:
providing an injection molding apparatus;
injection molding the polymer comprising polycarbonate;
heating the polymer up to about 300° F. to 350° F. while injecting the polymer; and
forming the mold portion.

19. The method of claim 18, including maintaining a holding pressure during cooling of the polymer.

20. A method for making a heat set plastic container, the method comprising:
providing a plurality of mold portions, the mold portions comprising a polymer and configured to form a mold cavity;
forming and heat setting a container for a hot-fill application.

21. A mold assembly for manufacturing blow molded plastic containers, the mold assembly comprising:
a plurality of mold portions that form a blow mold cavity configured to form all or a portion of a blow molded plastic container,
wherein the mold portions devoid of metal on a container contact surface and mold portion interface, and are primarily comprised of a polymer, the polymer forms the blow mold cavity for contact with said plastic containers to be formed from the mold assembly, the polymer comprises polycarbonate, and the polymer is an insulator; the polymer mold portions have a thermal conductivity (k) of less than about 0.5 W/(m·K); the mold portions include a filler; and the filler comprises up to 20%, by weight, of the mold portions.

22. The mold assembly of claim 1, wherein the surface of the blow mold cavity comprises a polymer and the surface of said molded plastic container comprises a plastic material.

23. The mold assembly of claim 1, wherein the mold portions are devoid of metal.

24. The mold assembly of claim 21, wherein the mold portions are devoid of metal.

25. The mold assembly of claim 21, wherein the wherein the polymer comprises a polycarbonate, the filler comprises fiberglass, and the mold portions include carbon black.
